(19) United States
(12) Patent Application Publication
(10) Pub. No.: US 2019/0121105 A1
(43) Pub. Date: Apr. 25, 2019

(54) DYNAMIC ZOOM LENS FOR MULTIPLE-IN-ONE OPTICAL SYSTEM TITLE

(71) Applicant: CentraLED Technology Co., Ltd., Taoyuan City (TW)

(72) Inventors: Chiu-Fen WANG, Taoyuan City (TW); Xuan-Hao LEE, Taoyuan City (TW)

(73) Assignee: CentraLED Technology Co., Ltd.

(21) Appl. No.: 16/166,528

(22) Filed: Oct. 22, 2018

Related U.S. Application Data
(60) Provisional application No. 62/575,027, filed on Oct. 20, 2017.

(51) Int. Cl. G02B 13/06; G02F 1/1335; G02B 27/10; G02B 7/04; G02B 13/02

(52) U.S. Cl. CPC G02B 13/06; G02F 1/133526; G02B 13/02; G02B 7/04; G02B 27/10

(57) ABSTRACT

This present invention discloses a dynamic zoom lens for multiple-in-one optical system, comprising: a moving member; a wide-angle lens capturing large range image; a first light sensing element converting the large range image into first image signal; a telephoto lens capturing partial image; a second light sensing element converting partial image into second image signal; an image processing module, comprising: an instant local searching unit electrically connected to the moving member; an image integration unit forming composite image; and a display module presenting composite image, and a user interface controlling the instant local searching unit to drive the moving member to perform an instantaneous local search.

### BACKGROUND OF THE INVENTION

### 1. Technical Field

The invention relates to a dynamic zoom lens for multiple-in-one optical system, in particular to a dynamic zoom lens for multiple-in-one optical system capable of performing local image detection or recognition with a high space-bandwidth product effect on a specific object selected in real time at any position within a large range of real-time images.

### 2. Description of Related Art

Security control system is no longer limited to monitoring in a specific place. In fact, in the process of digitalization, networking and the development of a new generation of IP Cam, currently develop application solutions that integrate smart monitoring systems and develop their own intelligent image monitoring systems. To develop more integrated applications, the difference in image-capturing functions becomes the key to success.

In addition to the monitoring system, general life applications also need to perform image capture and recognition. For example, when using a mobile phone, the camera lens can be used to identify faces, pupils, or irises. In many identification processes, local features are found from a large range. How to apply large-range and local image information at the same time to facilitate identification is an important issue.

### SUMMARY OF THE INVENTION

The invention relates to a dynamic zoom lens for multiple-in-one optical system, which mainly solves the problem of how to select a specific object in real time at any position in a large range of instant images for local image detection or recognition.

The present invention provides a dynamic zoom lens for multiple-in-one optical system a moving member formed on a first incident light path and the light exit side of the moving member generating a first beam path and a second beam path; a wide-angle lens formed on the first beam path and capturing at least one large range image in at least one target; a first light sensing element formed on the light exit side of the wide-angle lens and converting the at least one large range image into at least one first image signal; a telephoto lens formed on the second beam path and capturing at least one partial image of the at least one target; a second light sensing element formed on the light exit side of the telephoto lens and converting at least one partial image into at least one second image signal; an image processing module, comprising: an instant local searching unit electrically connected to the moving member; an image integration unit configured to read the at least one second image signal to combine with the at least one first image signal to form at least one composite image; and a display module configured to read the at least one composite image and presenting at least one composite image, and having a user interface controlling the instant local searching unit to drive the moving member to perform an instantaneous local search on the at least one target.

Implementation of the present invention at least produces the following advantageous effects:

1. Instantly selecting specific objects at any location within a large range of live images;
2. Integrating a wide range of live images with selected instant local images; and
3. Avoiding distortion when zooming in on live images.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE DRAWINGS

FIG. 1 is a system operation flowchart of the present invention;

FIG. 2A is a first embodiment of the first light sensing element of the present invention for capturing a large range image;

FIG. 2B is a first embodiment of the second light sensing element of the present invention for selecting a single object by a large range image;

FIG. 2C is a first embodiment diagram of a composite image produced by the image integration unit combining a large range scene with a selected single object;

FIG. 3A is a second embodiment of the first light sensing element of the present invention for capturing a large range image;

FIG. 3B is a second embodiment of the second light sensing element of the present invention, wherein two objects are selected by a large range scenes;

FIG. 3C is a second embodiment diagram of a composite image embodiment in which the image integration unit combines a large range scene with a selected two objects;

FIG. 4A is a third embodiment of the first light sensing element of the present invention for capturing a large range image;

FIG. 4B is a third embodiment of a second light sensing element of the present invention for selecting a single object by a large range image;

FIG. 4C is a composite image embodiment diagram of the image integration unit of the present invention combining a large range scene with a local feature of a selected single object;

FIG. 5A is an embodiment diagram of the first light sensing element for extracting a large range of human face when the invention is applied to the pupil identification;

FIG. 5B is a diagram showing an embodiment of the second light sensing element which use to choose a pupil through the human.

FIG. 5C is a composite image embodiment diagram of an image integration unit of the present invention combining a human face with a selected pupil;

FIG. 6A is a first embodiment diagram of a system architecture of a dynamic zoom lens for multiple-in-one optical system according to the present invention;

FIG. 6B is a system architecture diagram of a dynamic zoom lens multi-in-one optical system according to aspect 2 of a first embodiment of the present invention.

FIG. 7 is the second embodiment diagram of a dynamic zoom lens for multiple-in-one optical system architecture according to the present invention;

FIG. 8 is the third embodiment of a dynamic zoom lens for multiple-in-one optical system architecture of the present invention;

FIG. 9A is a state diagram 1 of a fourth embodiment of a system architecture of a dynamic zoom lens for multiple-in-one optical system of the present invention; and

FIG. 9B is a state diagram 2 of a fourth embodiment of a system architecture of a dynamic zoom lens for multiple-in-one optical system of the present invention.

### DETAILED DESCRIPTION OF THE INVENTION

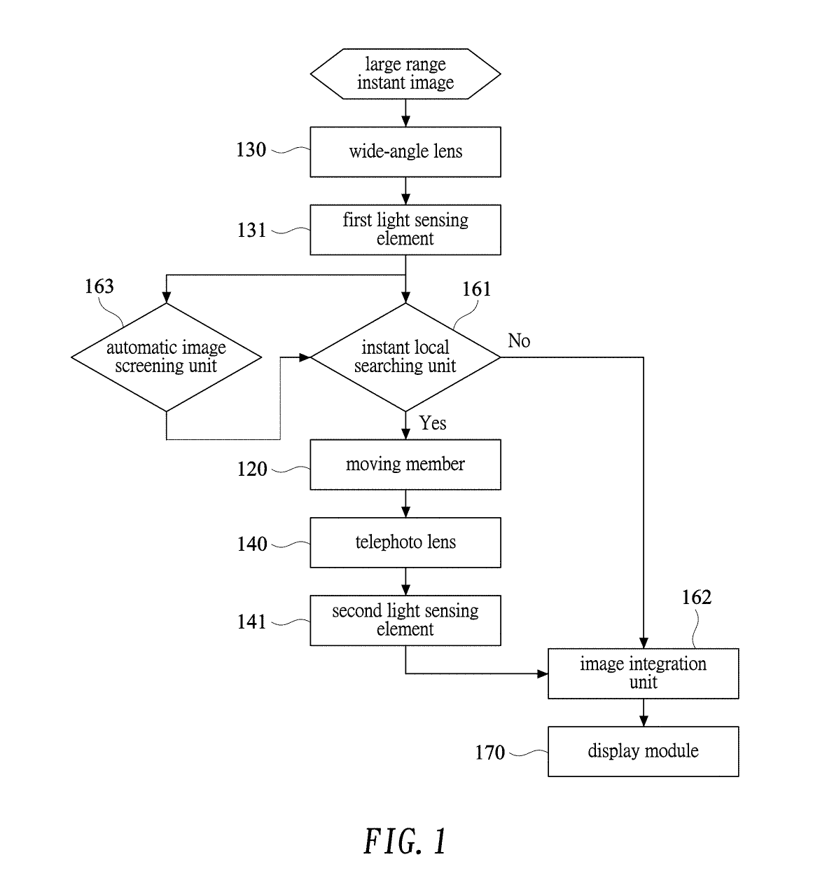

As shown in FIG. 1, the present invention is a full-optical scanning dynamic real-time image detection and recognition system capable of combining 2D and 3D image recognition, which uses a wide-angle lens 130 to instant detect a large range of scenes and image to the first light sensing element 131 corresponding to a wide-angle lens 130.

At least one of specific object selected for local image detection or recognition at any location within a large range of live images, you can quickly locate and frame the specific object in the screen by using an instant local searching unit 161 in the system. The instant local searching unit 161 then transmits a command to the moving member 120 with multi-axis high-speed swing, so that the specific object image enters the optical path of the telephoto lens 140. Finally, in the dynamic optical modulation mode, the second light sensing element 141 corresponding to the telephoto lens 140 instantly imaged, thereby produce an undistorted, instantly magnified image.

At the same time, the image integration unit 162 may perform image superimposition processing on a second image captured by the second light sensing element 141 and a first image captured by the first light sensing element 131 to form a composite image 164. The image integration unit 162 can synchronously present the composite image on a screen in a 2D or/and 3D image manner. In other words, the enlarged picture of the second imaging module 142 can insert into the wide-angle picture of the first imaging module 132, and becomes a large range overall picture combined with the local zoom in picture. By the modulation of Space-bandwidth Product (SBP) can effectively solve the problem of image blurring caused by digital image processing in the process of partial image enlargement.

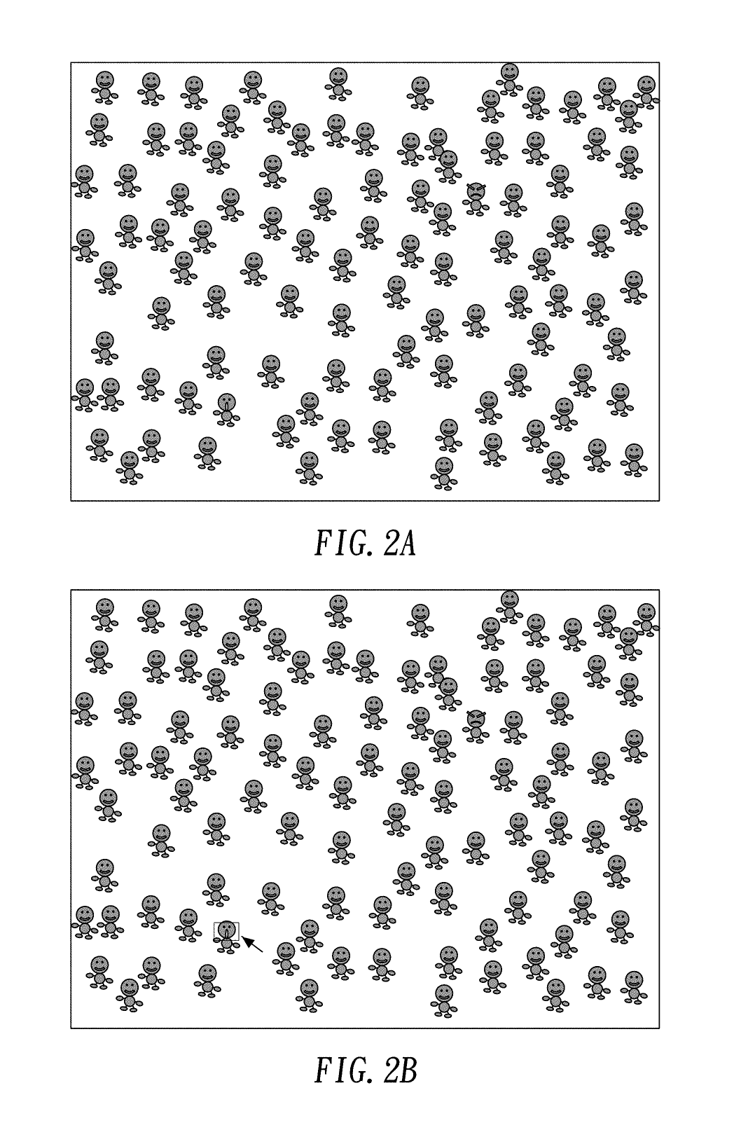

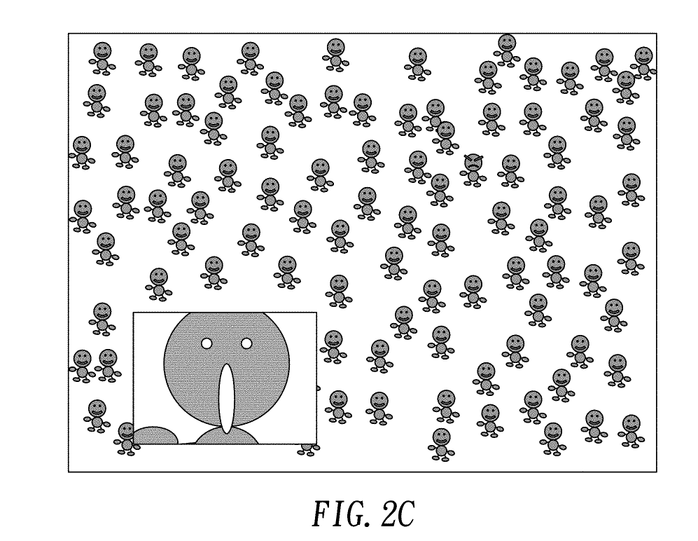

As shown in FIG. 2A-2C, in actual application, FIG. 2A is a first image of a large range of scenes captured by the first light sensing element 131. The arrow in FIG. 2B shows that the moving member 120 is controlled to perform a partial real-time search using the instant local searching unit 161, so that the second light sensing element 141 selects a single object by the first image. FIG. 2C is an object that is selected by a telephoto lens 140 in the first image to magnify by dynamic optical modulation, and the second light sensing element 141 generates an undistorted instantaneous partial enlarged second image. The image integration unit 162 integrates the second image and the first image into a composite image and output the composite image to a display module 170 to present a composite picture.

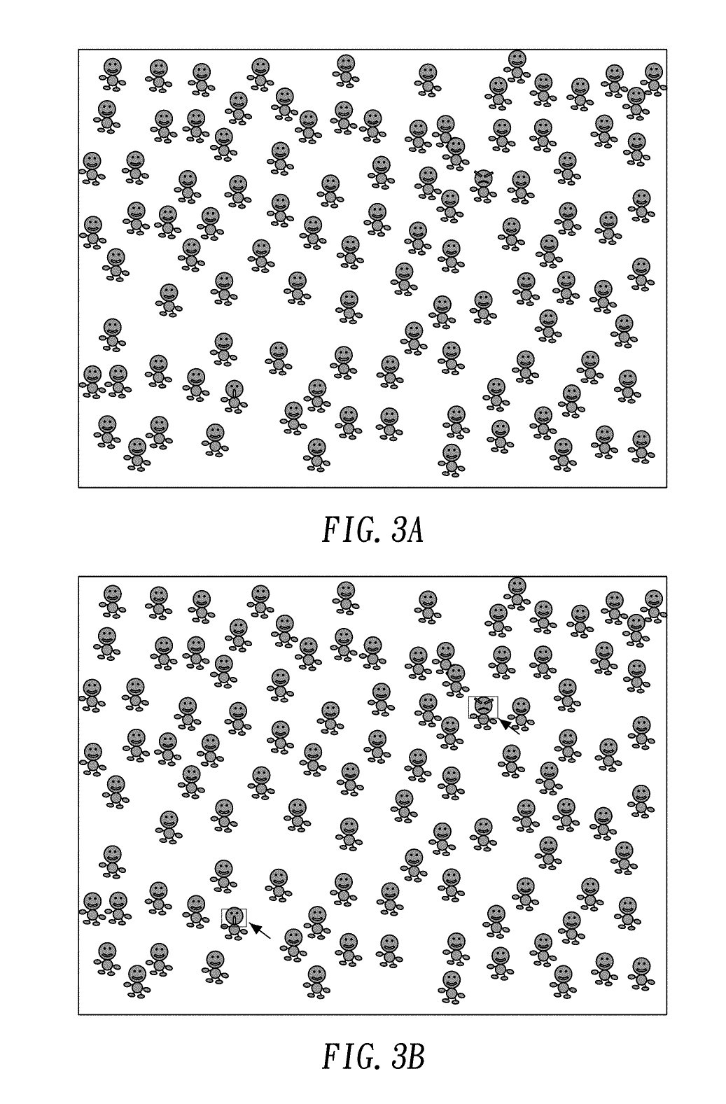

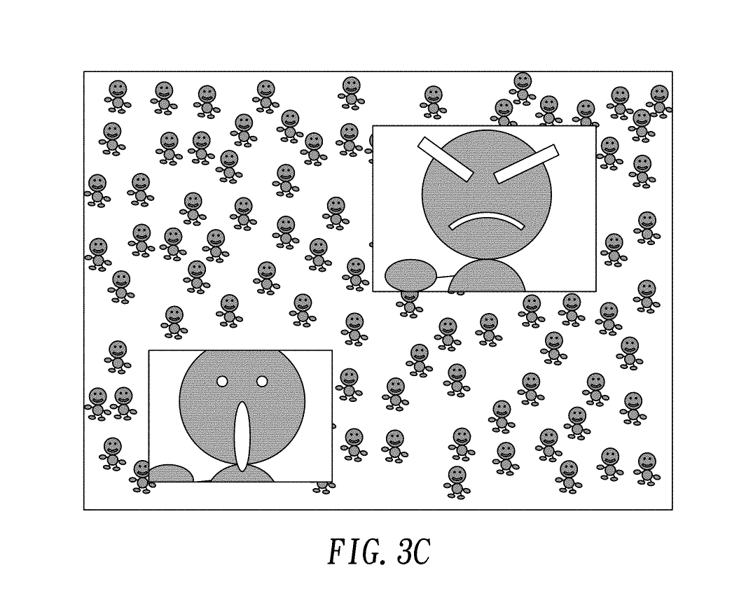

As shown in FIG. 3A-3C, this embodiment operates in the almost same way as described above, but the difference from the above operation mode is that above operation mode selects a single object, but FIG. 3A-3C select two or more objects at the same time. Therefore, the image integration unit 162 integrates the selected two objects with the first image into a composite image and outputs the composite image to the display module 170 to present a composite picture.

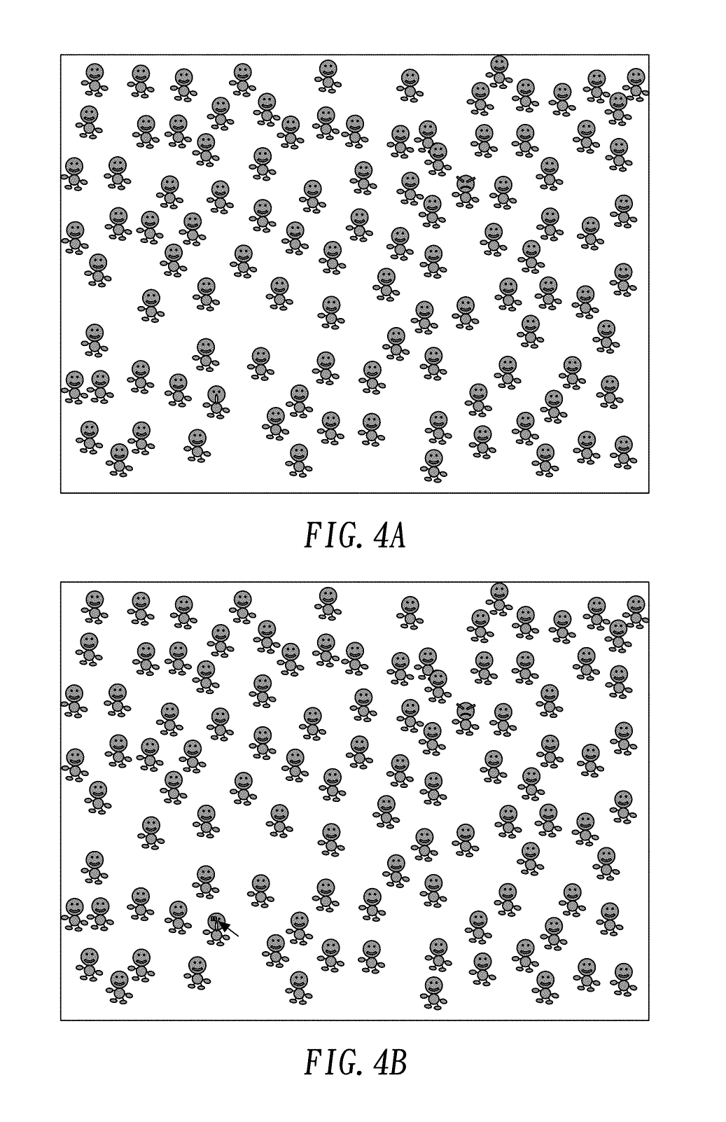

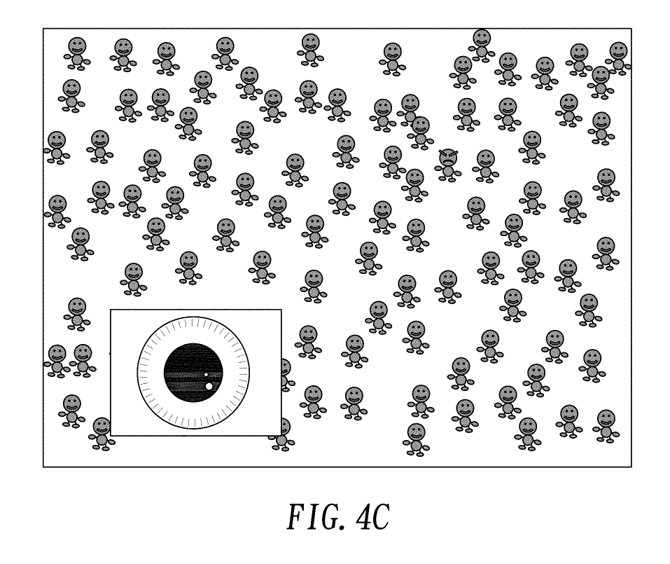

As shown in FIG. 4A-4C, it operates in the almost same way as described above, but the difference from the above operation mode is that above operation mode selects a single object or multiple objects, but FIG. 4A-4C select local features for single or multiple objects. Therefore, the image integration unit 162 combines the local features of the selected single or multiple objects with the first image into a composite image, and outputs the composite image to the display module 170 to present a composite picture.

The present invention can be applied to any device that needs to perform image capturing, such as a camera, a head-up display, a periscope, a remote detection, an image observation system, etc., and can also combined with a mobile phone. Wherein the moving parts with multi-axis high-speed swing and anti-shake component built in a mobile phone can be further combined for real-time image capturing.

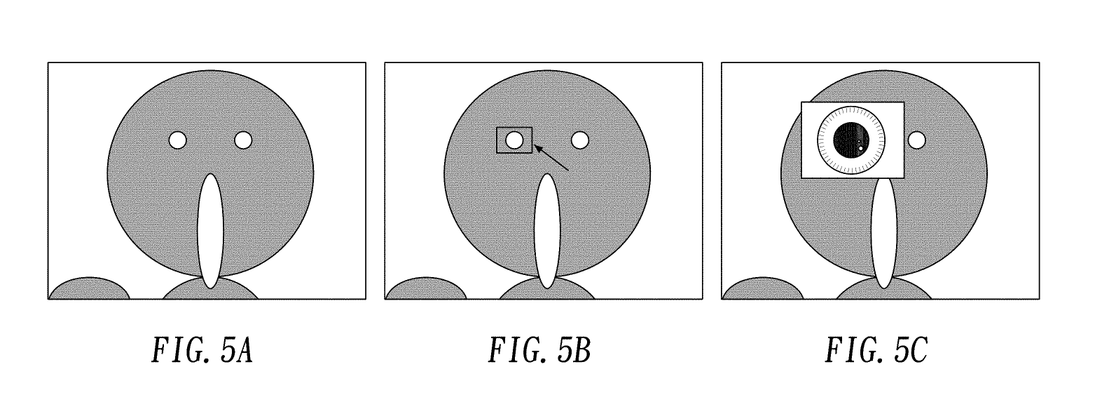

As shown in FIG. 5A-5C, the present invention is used as a face 2D recognition device having pupil recognition. FIG. 5A is a first image of a large range of human face captured by the first light sensing element 131. The arrow in FIG. 5B shows that the moving member 120 is controlled by the instant local searching unit 161 for local instant search, so that the second light sensing element 141 selects the pupil part of the human eye by the first image. FIG. 5C is a dynamic optical modulation method for the human eye pupil selected in the first image by a telephoto lens 140. Then the local light sensing element 141 produces an undistorted instantaneous partial magnification of the human eye pupil, which integrate with the human face into a composite image by using the image integration unit 162 and outputs the composite image 164 to the display module 170 to present a composite picture.

### First Embodiment

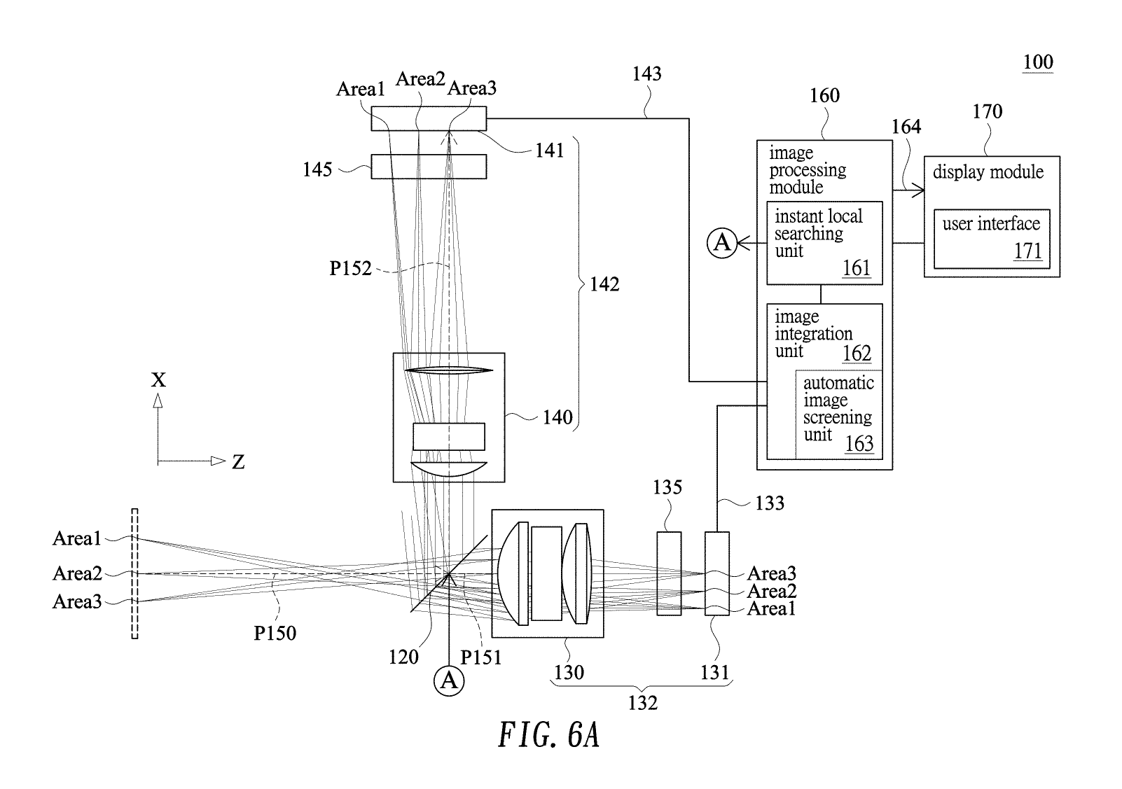

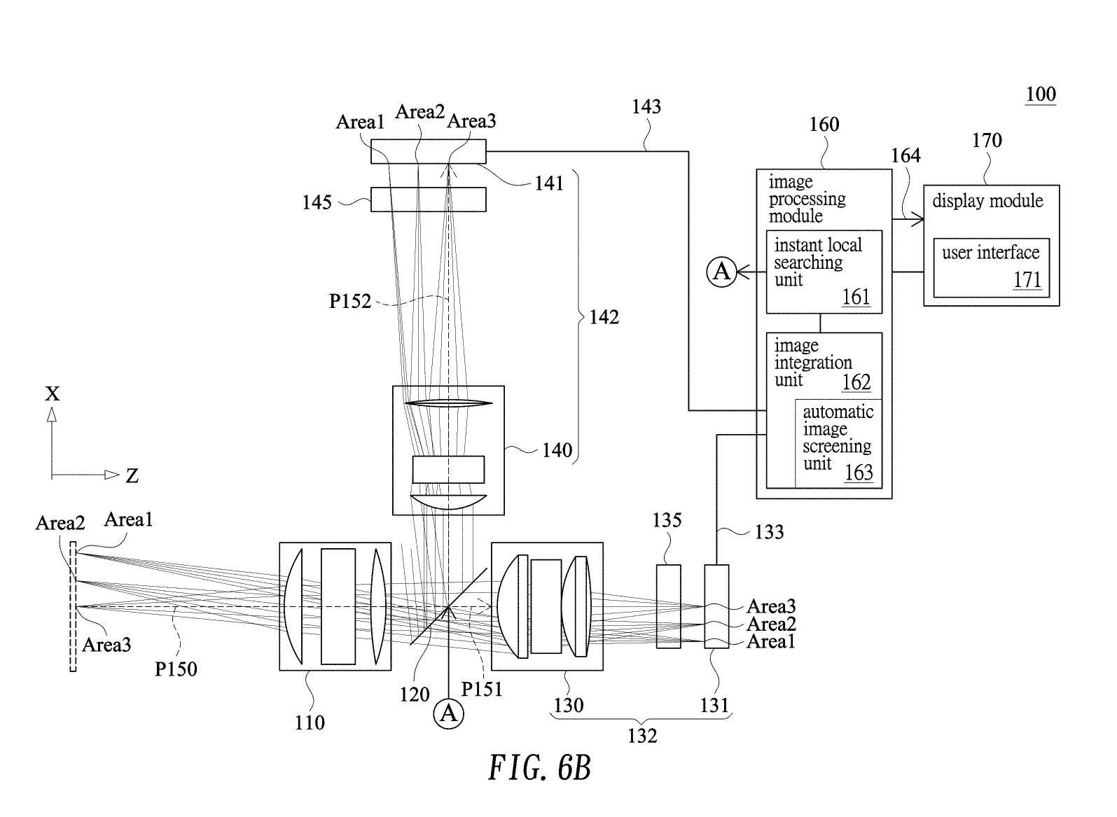

As shown in FIG. 6A, a first embodiment of multi-in-one optical dynamic zoom lens system or dynamic zoom lens for multiple-in-one optical system 100 comprises: a moving member 120, a wide-angle lens 130, a first light sensing element 131, a telephoto lens 140, a second light sensing element 141, an image processing module 160, and an image display module 170. Image processing module 160 comprises an instant local searching unit 161 and an image integration unit 162. The external image can directly capture by the wide-angle lens 130 and the telephoto lens 140.

As shown in FIG. 6B, the FIG. 6A may further comprise a first objective lens 110. The first objective lens 110 is disposed on the first incident light path P150 for capturing at least one first target image, at least one large range image and at least one partial image, of at least one target. At this time, the image of the object in the environment enters the dynamic zoom lens for multiple-in-one optical system 100 by the first objective lens 110 and forms a first incident light path P150 having a common optical axis with the dynamic zoom lens for multiple-in-one optical system 100.

The moving member 120 forms on a first incident light path P150. The moving member 120 is a beam splitting element having multi-axis and high-speed swing, which perform two-dimensional or multi-axis high-speed swings of up, down, left or right by controlled of the instantaneous local searching unit 161. The moving member 120 can search different areas, Area1, Area2, or Area3, etc., of the object or target image, and image to the second light sensing element 141 through the telephoto lens 140.

Passing through the moving member 120, the light exit side of the moving member 120, the first incident light path P150 generates the first beam path P151 projected to the wide-angle lens 130 and the second beam path P152 projected to the telephoto lens 140.

The wide-angle lens 130 can be a lens, a lens set, or a zoom lenses unit, so that large range image capturing can perform optically, that is capturing at least one large range image in the at least one target. The wide-angle lens 130 forms on the first beam path P151. The light-emitting side of the wide-angle lens 130 provides with a first light sensing element 131 for converting at least one large range image into at least one first image signal 133. The first light sensing element 131 can be a high-pixel 2D array of light-sensing elements, such as CMOS light-sensing elements.

The first light sensing element 131 formed on the light exit side of the wide-angle lens 130 can sense for different spectrum, for example, can sense visible light or infrared light. The wide-angle lens 130 and the first light sensing element 131 form a first imaging module 132. The first light sensing element 131 mainly converts at least one large range of real-time images into at least one first image signal.

The telephoto lens 140 can be a lens, a lens set, or a zoom lenses unit, so that the partial magnification imaging can perform optically, that is capturing at least one partial image of at least one target. The telephoto lens 140 forms on the second beam path P152. The light-emitting side of the telephoto lens 140 provides with a second light sensing element 141 for converting at least one partial image into at least one second image signal 143. The second light sensing element 141 can be a high-pixel 2D array of light-sensing elements, such as a CMOS light-sensing element.

The second light sensing element 141 formed on the light exit side of the telephoto lens can sense for different spectrum, for example, can sense visible light or infrared light. The telephoto lens 140 and the second light sensing element 141 form a second imaging module 142. The second imaging module 142 mainly detects real-time partial images of different regions Area1, Area2, or Area3, etc. in a large range instant object or target image. The second light sensing element 141 converts at least one partial image into at least one second image signal.

The instant local searching unit 161 electrically connected to the moving member 120 implements in image processing module 160 as a hardware circuit or software, and can accept a command from the user inputting on the user interface 171. After reference the first image which image integration unit 162 receives from the wide-angle lens 130, the instant local searching unit 161 can control the moving member 120 to perform an instant local search, for example, an instant partial image search for areas such as Area1, Area2, or Area3.

The image integration unit 162 configures to read the at least one partial image signal, the second image signal 143, of the second light sensing element 141 to combine with the at least one first image signal 133 to form at least one composite image 164, and then output the composite image to display module 170 to present a composite picture.

The image integration unit 162 may further comprises an automatic image screening unit 163 that automatically filters at least a large range of the image inputted by the wide-angle lens 130 by using an automated optical inspection (AOI) technique. When the at least one object preset in the automatic image screening unit is filtered out, the image integration unit 162 notifies the instant local searching unit 161 to control the moving member 120 to enable the telephoto lens 140 to perform partial image capturing on the selected at least one object.

For example, when the all-in-one optical system 100 is disposed on a traffic lane, images such as a person, a vehicle, a small animal, etc. may continuously enter the wide-angle lens 130. At this time, since the automatic image screening unit 163 has a built-in human face as a feature for screening; so that, when human faces entering the wide-angle lens 130, the automatic image screening unit 163 automatically transmits an instruction to the instant local search processing unit 161 after the feature, face, is recognized, so as to control the moving member 120 to make the telephoto lens 140 capturing human face or local features of the human face, such as a pupil or iris, then performing subsequent pupil or iris recognition.

The display module 170 configured to read at least one composite image and presenting at least one composite image can be a liquid crystal display. In addition to displaying the first image signal, the second image signal, or the composite image 164, the image display module 170 can further has a user interface 171. For example, the user interface 171 that controls the real-time local searching unit 161 to operate. The user interface 171 can control the instant local searching unit 161 to drive the moving member 120, and then perform an instantaneous local search on the at least one target.

The first light sensing element or the second light sensing element may be a 2D array light sensing elements. In front of any 2D array light sensing elements, the first light sensing element 131 or the second light sensing element 141, can further comprises a liquid crystal lens adjusted the focus position as needed.

In the overall application, the first imaging module 132 mainly detects a large range of real-time images. The second imaging module 142 instantly images the partial image of any position in the large range of real-time images by swinging the multi-axis high-speed swinging moving member 120 and in a dynamic optical modulation manner to the second imaging module 142. By the modulation of Space-bandwidth Product (SBP) to produce an undistorted and instantly magnified image can effectively solve the problem of image blurring caused by digital image processing in the process of partial image enlargement.

In addition, the large range of images imaged by the wide-angle lens 130 does not cause real-time image disturbance due to the disturbance of the moving member 120. Therefore, the partially enlarged image can combine with a large range of real-time images, and can be instantly displayed on a screen by the image integration unit 162 in a 2D or/and 3D images manner. The enlarged picture of the second imaging module 142 can insert into the wide-angle picture of the first imaging module 132 to become an overall picture with local imaging in zoom in manner.

This embodiment can apply to a face 2D recognition device with pupil recognition. The 2D instant recognition of the face can perform on the first imaging module 132 composed of the wide-angle lens 130. The moving member 120 capable of multi-axis high-speed swinging can quickly enlarge the pupil position by the second imaging module 142 composed of the telephoto lens 140 to perform instant pupil or iris amplification. In this way, at the wide angle, the face features can image by the long lens for further face recognition or iris recognition.

### Second Embodiment

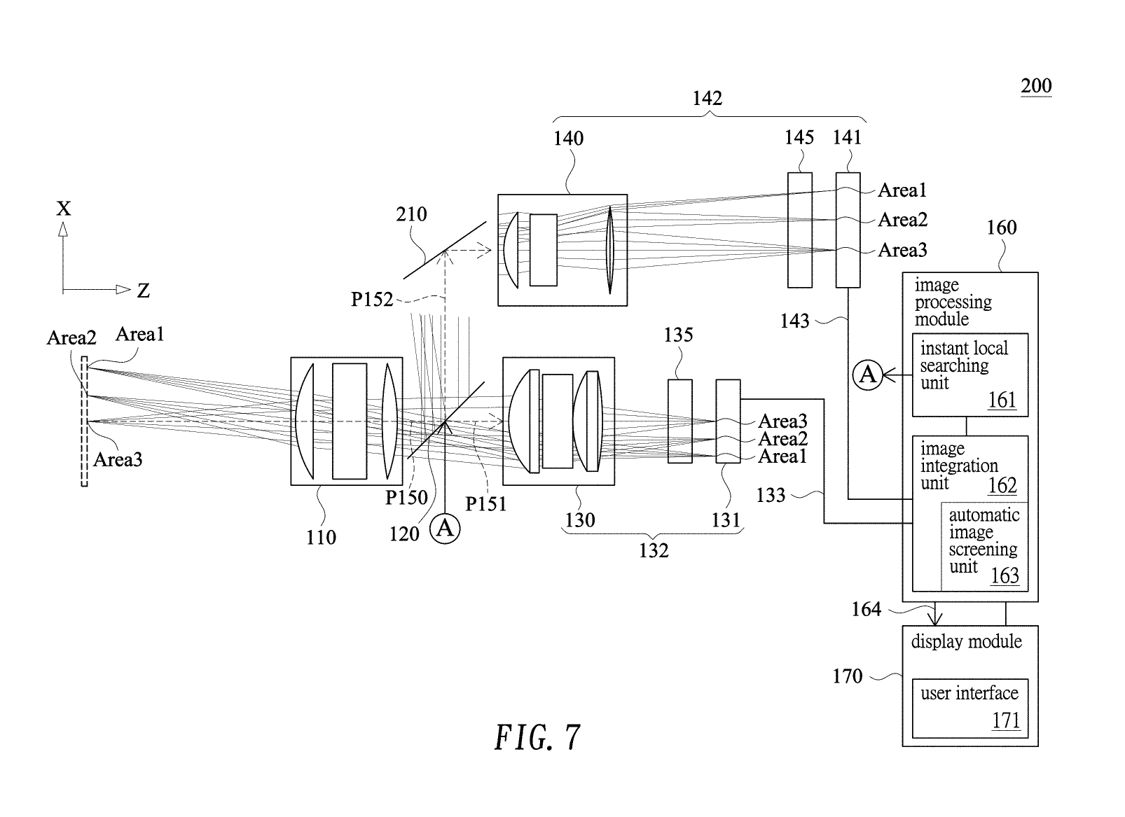

As shown in FIG. 7, the dynamic zoom lens for multiple-in-one optical system 200 of the second embodiment which is the dynamic zoom lens multi-integration optical system 100 of the first embodiment further having a first reflective element 210 formed on the second beam path P152.

The first reflective element 210 can be a multi-axis high-speed swing performance mirror, and the first reflective element 210 has a 2-axis actuation. Thereby, the telephoto lens 140 can more efficiently locks and zoom the selected object by the first reflective element 210.

### Third Embodiment

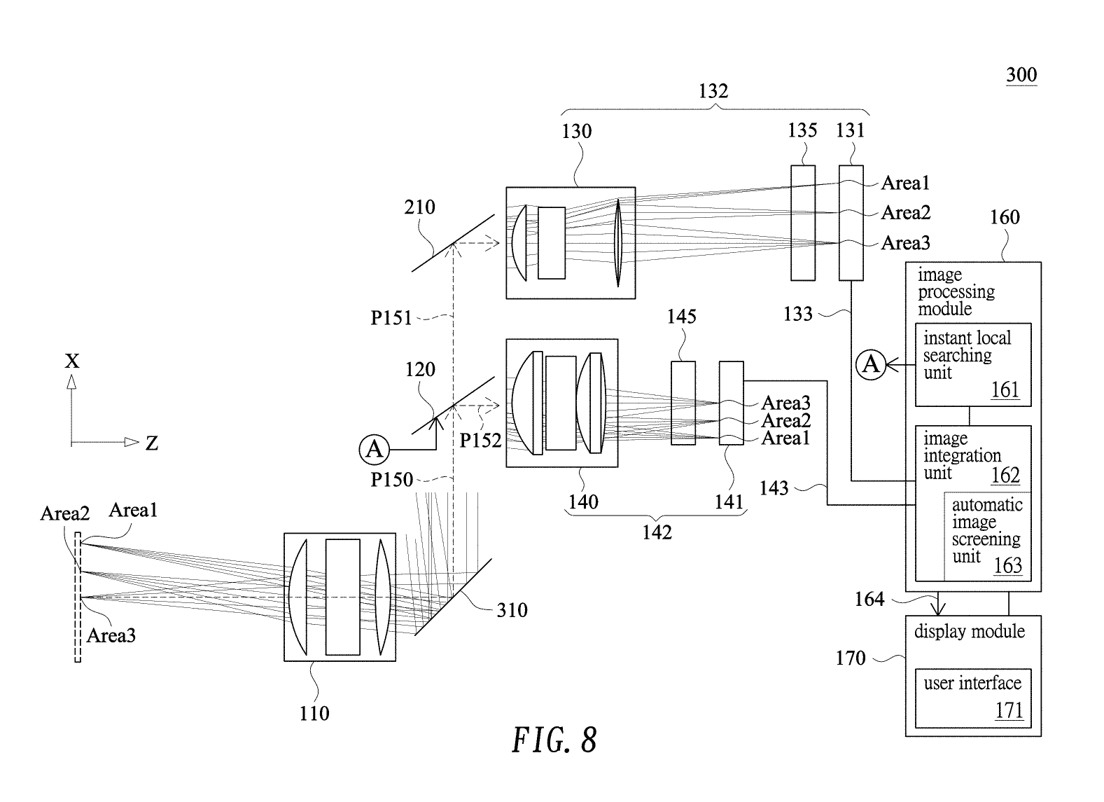

As shown in FIG. 8, the all-in-one optical system 300 of the dynamic zoom lens of the third embodiment which is the all-in-one optical system 200 of the dynamic zoom lens of the second embodiment further having a second reflective element 310 formed on the first incident light path P150 and in between the first objective lens and the moving member 120.

The second reflective element 310 can be a multi-axis high-speed swing performance mirror, and the same second reflective element 310 has a 2-axis actuation. Thereby, the first imaging module 132 and the second imaging module 142 can more efficiently lock and zoom by the second reflective component 310.

### Forth Embodiment

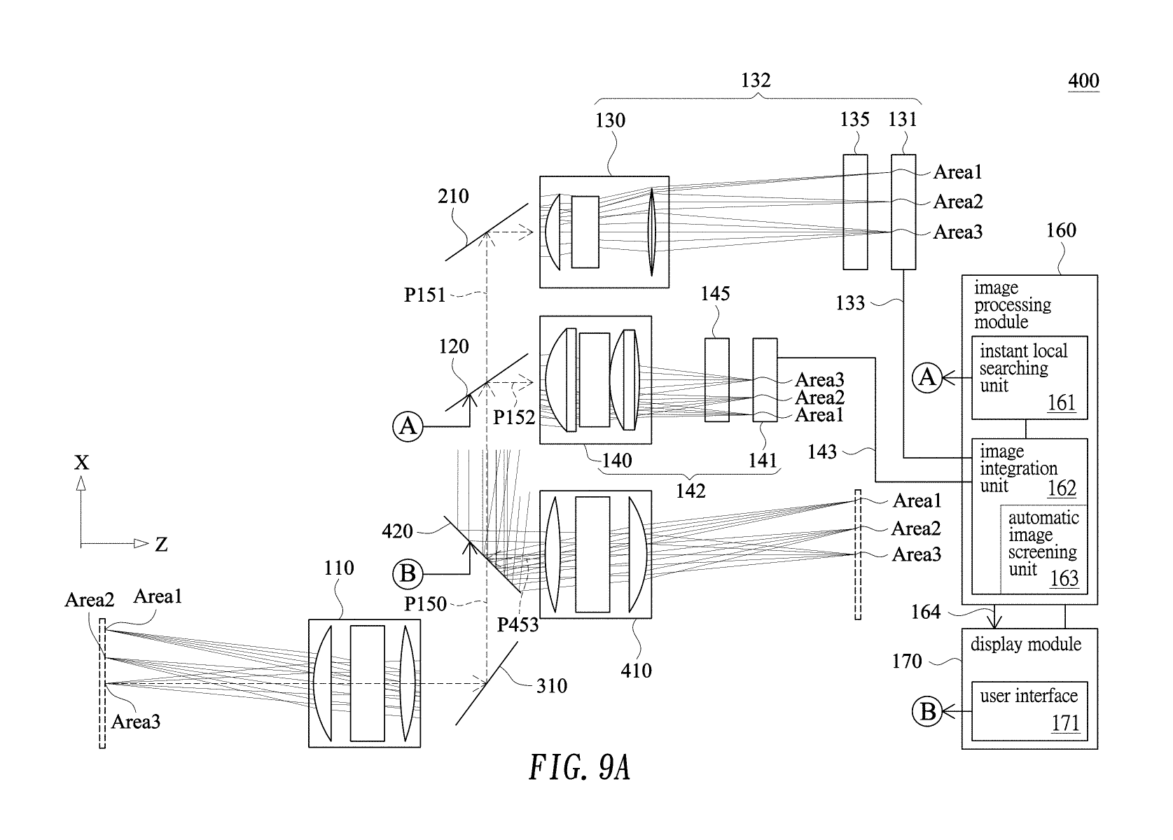

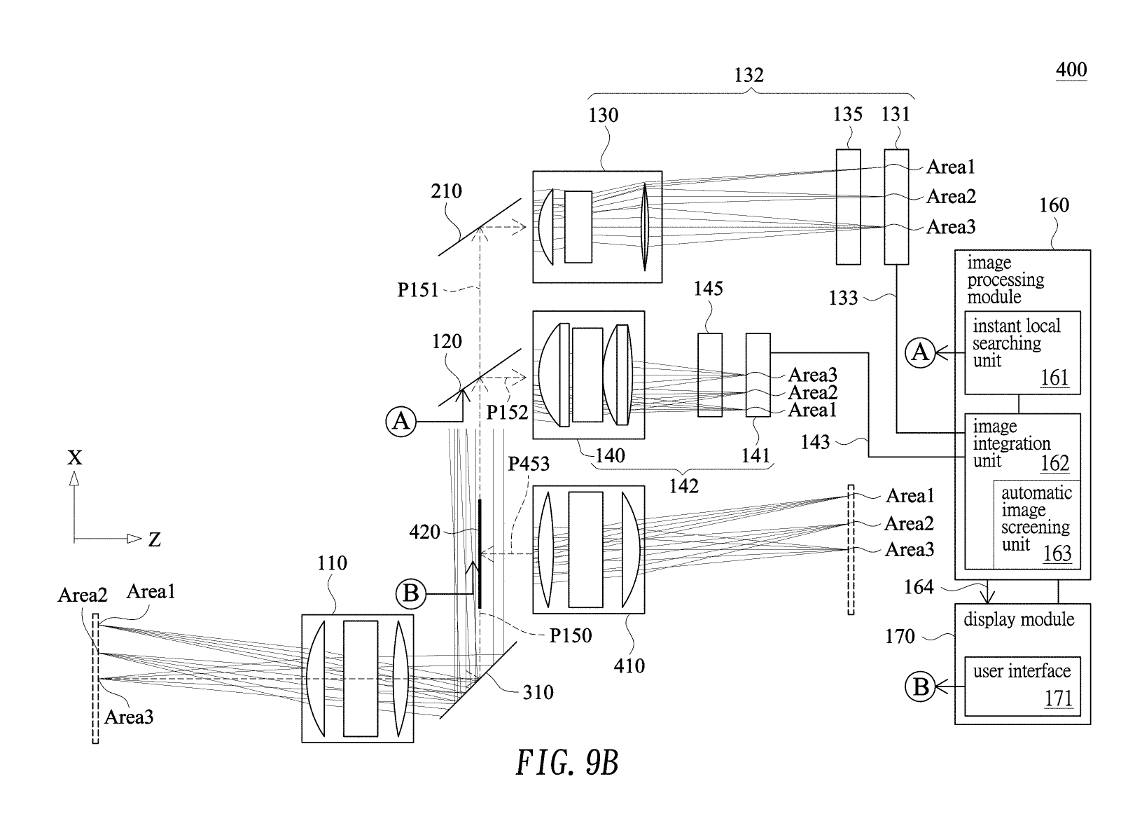

As shown in FIG. 9A and FIG. 9B, the dynamic zoom lens for multiple-in-one optical system 400 of the fourth embodiment which is the dynamic zoom lens for multiple-in-one optical system 300 of the third embodiment further having a second objective lens 410 configured to capture a second target image of at least one target image and formed with a second incident light path P453. At this time, if the first objective lens 110 and the second objective lens 410 use as an example of a smart phone, they are like a general lens and a selfie lens on a mobile phone.

In the above architecture, the dynamic zoom lens for multiple-in-one optical system 400 of the fourth embodiment adds a third reflective element 420 disposed on the second incident light path P453 and in between the second reflective element 310 and the moving member 120 for reflecting the second incident light to the moving member 120. The user interface 171 can control the third reflective element 420 to selectively an input from the first target image or the second target image.

The third reflective element 420 is used to reflect the second incident light to the moving member 120. Similarly, the light incident on the second incident light path P453 passes through the moving member 120, and generates the first beam path P151 and the beam path P152.

In order to make the first imaging module 132 and the second imaging module 142 be shared by the first objective lens 110 and the second objective lens 410, the third reflective element 420 is a rotatable structure. That is, the third reflective element 420 can rotate to select an image signal from the first objective lens 110 or the second objective lens 410, and the selected image signal can project to the moving member 120. Therefore, the first imaging module 132 and the second imaging module 142 can share by the first objective lens 110 and the second objective lens 410.

The above description is only the preferred embodiments of the present invention, and is not intended to limit the present invention in any form. Although the invention has been disclosed as above in the preferred embodiments, they are not intended to limit the invention. A person skilled in the relevant art will recognize that equivalent embodiment modified and varied as equivalent changes disclosed above can be used without parting from the scope of the technical solution of the present invention. All the simple modification, equivalent changes and modifications of the above embodiments according to the material contents of the invention shall be within the scope of the technical solution of the present invention.

What is claimed is:

1. A dynamic zoom lens for multiple-in-one optical system, comprising:
a moving member formed on a first incident light path and the light exit side of the moving member generating a first beam path and a second beam path;
a wide-angle lens formed on the first beam path and capturing at least one large range image in at least one target;
a first light sensing element formed on the light exit side of the wide-angle lens and converting the at least one large range image into at least one first image signal;
a telephoto lens formed on the second beam path and capturing at least one partial image of the at least one target;
a second light sensing element formed on the light exit side of the telephoto lens and converting at least one partial image into at least one second image signal;
an image processing module, comprising:
an instant local searching unit electrically connected to the moving member; and
an image integration unit configured to read the at least one second image signal to combine with the at least one first image signal to form at least one composite image; and
a display module configured to read the at least one composite image and presenting at least one composite image, and having a user interface controlling the instant local searching unit to drive the moving member to perform an instantaneous local search on the at least one target.

2. The dynamic zoom lens for multiple-in-one optical system of claim 1, further comprises a first objective lens disposed on the first incident light path for capturing a first target image of the at least one target.

3. The dynamic zoom lens for multiple-in-one optical system of claim 1, in front of the first light sensing element or the second light sensing element further comprises a liquid crystal lens.

4. The dynamic zoom lens for multiple-in-one optical system of claim 2, further comprises a first reflective element formed on the second beam path.

5. The dynamic zoom lens for multiple-in-one optical system of claim 4, further comprises a second reflective element formed on the first incident light path and in between the first objective lens and the moving member

6. The dynamic zoom lens for multiple-in-one optical system of claim 5, further comprises a second objective lens configured to capture a second target image of at least one target and formed with a second incident light path and a third reflective element disposed on the second incident light path and in between the second reflective element and the moving member, and the user interface control the third reflective element to selectively an input from the first target image or the second target image.

7. The dynamic zoom lens for multiple-in-one optical system of claim 1, wherein the moving member is a beam splitting element having multi-axis and high-speed swing.

8. The dynamic zoom lens for multiple-in-one optical system of claim 1, wherein the first light sensing element or the second light sensing element is a 2D array light sensing elements.

9. The dynamic zoom lens for multiple-in-one optical system of claim 1, wherein the first light sensing element or the second light sensing element is a visible light or an infrared light sensing element.

10. The dynamic zoom lens for multiple-in-one optical system of claim 1, wherein the wide-angle lens or the telephoto lens is a lens, a lens set, or a zoom lenses unit.

11. The dynamic zoom lens for multiple-in-one optical system of claim 1, wherein the image integration unit further comprises an automatic image screening unit that automatically filters at least a large range of the image inputted by the wide-angle lens by using an automated optical inspection (AOI) technique, and when the at least one object preset in the automatic image screening unit is filtered out, the image integration unit notifies the instant local searching unit to control the moving member to enable the telephoto lens to perform partial image capturing on the selected at least one object.
